(19) United States
(12) Patent Application Publication
(10) Pub. No.: US 2006/0192350 A1
(43) Pub. Date: Aug. 31, 2006

(54) Chuck

(75) Inventors: Werner Kleine, Achim (DE); Werner Britten, Saarbruecken (DE)

Correspondence Address: ABELMAN, FRAYNE & SCHWAB, 666 THIRD AVENUE, 10TH FLOOR, NEW YORK, NY, 10017, US

(73) Assignee: Hilti Aktiengesellschaft

(21) Appl. No.: 11/361,781

(22) Filed: Feb. 24, 2006

(30) Foreign Application Priority Data
Feb. 25, 2005 (DE) 10 2005 000 015.0

(51) Int. Cl. B23B 31/00

(52) U.S. Cl. 279/19.3

(57) ABSTRACT

A chuck for receiving a working tool driven by a power tool includes a hollow cylindrical sleeve (4) for receiving the working tool (2), strip-shaped, rotation-transmitting webs (5a, 5b) projecting radially inward from the receiving sleeve (4), at least one radially displaceable locking member (7a); at least two guide members (9a, 9b) provided in a working tool-side guide region (F) of the guide diameter (D) of the receiving sleeve and spaced from the rotation-transmitting webs (5a, 5b), and a manually rotatable clamping sleeve (8a) for displacing the guide members (9a, 9b) radially inwardly.

### BACKGROUND OF THE INVENTION

1. Field of the Invention

The present invention relates to a chuck with radially displaceable locking members, in particular, for a combination hammer drill for receiving a percussion or a rotary borer.

2. Description of the Prior Art

Percussion and rotary working tools have a shank with which the tool is formlockingly received in a chuck for joint rotation therewith and for limited axial displacement relative thereto. The tool is axially secured with at least one radially displaceable locking member extendable in a groove formed in the shank and closed at its power tool-side end.

German Publications DE 19724532 and DE 3205063 both disclose a chuck having a hollow cylindrical receiving sleeve having a guide diameter and strip-shaped rotation-transmitting web projecting radially inward, and a radially displaceable locking member.

Practically standardized shanks and associated chucks, which are presently used worldwide in hammer drill systems, are described in U.S. Pat. No. 4,107,949. The shanks have a working tool-side cylindrical guide surface with a guide diameter of 10 mm and with locking grooves axially closed at the free end surface and with trapezoidal rotation-transmitting grooves axially open at the free end surface. When the shank is received in a chuck, at least one radially displaceable locking member engages in a locking groove of the shank, limiting the axial movement of the tool in the receiving sleeve of the chuck. Two opposite rotation-transmitting webs engage in respective rotation-transmitting grooves of the shank, transmitting the torque by their respective tangential contact surfaces. In such chucks, the rotary borer, such as a wood or metal borer, which is received with its shank in the chuck and which is not secured with a possibility of a limited axial displacement, cannot be guided with a required concentric precision only with susceptible to wear receiving sleeve with rotation-transmitting webs.

German Publication DE 4328358 discloses a suitable for the above-discussed shank, combination chuck with fixed rotation-transmitting webs and radially displaceable locking members and having three displaceable, both axially and radially, clamping members displaceable by a rotatable clamping sleeve with end face teeth, and which are formed as clamping jaws shaped as inner cones and are located in front of the locking members and the rotation-transmitting webs. At the rotary boring, the clamping jaws, which are pressed radially inward against a cylindrical stem of the shank, clamp the rotary borer forcelockingly in the chuck by static friction. Thereby, both the necessary torque and the axial displacement force are applied by the clamping jaws the clamping surfaces of which have a clamping length that amounts to about double of the guide diameter. However, because of the large surface of the axially displaceable clamping jaws, the axial constructional length of the chuck is rather long. Further, clamping the rotary borer with the clamping sleeve having end face teeth requires use of an auxiliary chuck spanner.

German Publications DE 3409494 discloses a chuck with three clamping jaws which are radially displaceable by a rotatable clamping sleeve with end face toothing that cooperates with an end face helical toothing on the chuck. The receiving sleeve has no fixed rotation-transmitting webs. The clamping jaws, which have a clamping length corresponding to the guide diameter of the receiving sleeve, provide, during rotary boring, for both transmission of the required torque and for the application of the axial displacement force as a result of forcelocking engagement produced by static friction. During percussion boring, the clamping jaws loosely lockingly engage in three associated locking grooves, transmitting the torque by their tangential contact surfaces. The clamping of a rotary borer with a clamping sleeve having end face toothing requires use of a spanner as an auxiliary tool. Moreover, the chuck described above is incompatible with above-discussed shanks which are used worldwide.

German Publication DE 3515555 and U.S. Pat. No. 4,469,201 disclose locking members fonned as radial inner segments of a jacket of a hollow cylinder.

The object of the invention is to provide a chuck suitable for both rotary boring and the percussion boring and having a shorter constructional length.

Another object of the present invention is to provide a chuck that would insure a precise concentric clamping of a rotary borer, without the use of any auxiliary tool.

### SUMMARY OF THE INVENTION

These and other objects of the present invention, which will become apparent hereinafter, are achieved by providing, in a working-tool side guide region of the receiving sleeve, at least two guide members which are displaced radially inwardly by a manually rotatable clamping sleeve. Accordingly, a chuck according to the present invention includes a hollow cylindrical sleeve for receiving working tool, strip-shaped rotation-transmitting webs projecting radially inward from the receiving sleeve and having contact surfaces, at least one radially displaceable locking member, at least two guide members provided in a working too-side guide region of the guide diameter and spaced from the rotation-transmitting webs, and a manually rotatable clamping sleeve for displacing the guide members radially inwardly.

During rotary boring, the necessary torque and displacement force is transmitted by the fixed strip-shaped rotation-transmitting webs, and the working tool is secured against falling-out with the locking member or members. The guide members serve for an exact coaxial alignment of the shank of the rotary borer in a further guide region of the susceptible to wear, receiving sleeve, which shank is spaced from the guide diameter by a clearance. Thus, no large clamping surface for forcelocking by static friction is necessary. Rather, there is provided a small guide surface with a shorter axial guide length for a positive forcelocking connection. With the guide members having a shorter axial guide length, a chuck with a reduced length is produced.

Advantageously, the guide members are arranged between the rotation-transmitting webs with a possibility of a tangential displacement therebetween. This reduces the constructional length of the chuck further.

Advantageously, the axial guide length of the guide members amounts to between half and total of the guide diameter. As a result, the guide members can be integrated in a conventional working-tool side guide region of the receiving sleeve for the worldwide used shank discussed above.

Advantageously, the maximum possible rotational angle of the clamping sleeve amounts up to 120°, which permits to obtain a quick-action chuck. Because upon the radial displacement of the guide members, a clearance of only 0.1 mm need be bridged and no clamping pressure need be applied, the clamping sleeve can be manually rotated without use of an auxiliary tool.

Advantageously, the guide members are located radially outwardly of the guide diameter by at least 0.1 mm in a rotational position of the clamping sleeve. As a result, during the percussion boring, the guide members are not subjected to wear by the percussion borer which reciprocates in the receiving sleeve.

Advantageously, the clamping sleeve has at least one slide guide formed therein along which the radially displaceable guide members slide upon rotation of the clamping sleeve. Thereby an arbitrarily constant displacement of the guide members, dependent on the rotational angle, can be easily realized.

Advantageously, in addition to the at least two guide members which form a front guide set, there are provided at least two further guide members one of which is formed by the at least one locking member and which form a rear guide set arranged in a power tool-side guide region spaced from the working tool side region, and a further rotatable clamping sleeve for radially displacing the further guide members. Thereby, a highly precise double guidance is achieved.

Advantageously, the guide members of at least one group are formed as segments of a hollow cylinder jacket. Thereby, there is provided a lateral positive surface extending transverse to the displacement of the guide members.

Advantageously, one of the guide sets has three, uniformly circumferentially spaced guide members. This makes a direct, two-dimensional centering of a shank possible.

Advantageously, there are provided two locking members which in addition to the locking function, also perform the guide function.

The novel features of the present invention, which are considered as characteristic for the invention, are set forth in the appended claims. The invention itself, however, both as to its construction and its mode of operation, together with additional advantages and objects thereof, will be best understood from the following detailed description of preferred embodiments, when read with reference to the accompanying drawings.

### BRIEF DESCRIPTION OF THE DRAWINGS

The drawings show:

FIG. 1 a longitudinal cross-sectional view of the chuck according to the present invention;

FIG. 2 a cross-sectional view along line Ia-Ia in FIG. 1;

FIG. 3 a cross-sectional view along line IIb-IIb in FIG. 1;

FIG. 4 a cross-sectional view corresponding to the cross-sectional view along line IIb-IIb in FIG. 1 of another embodiment of a chuck according to the present invention.

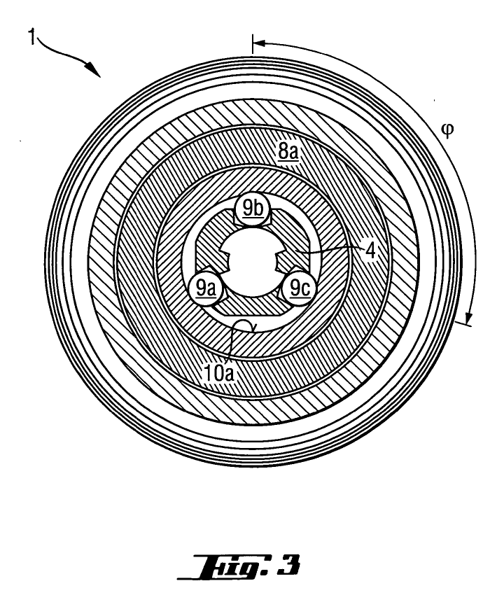

### DETAILED DESCRIPTION OF THE PREFERRED EMBODIMENT

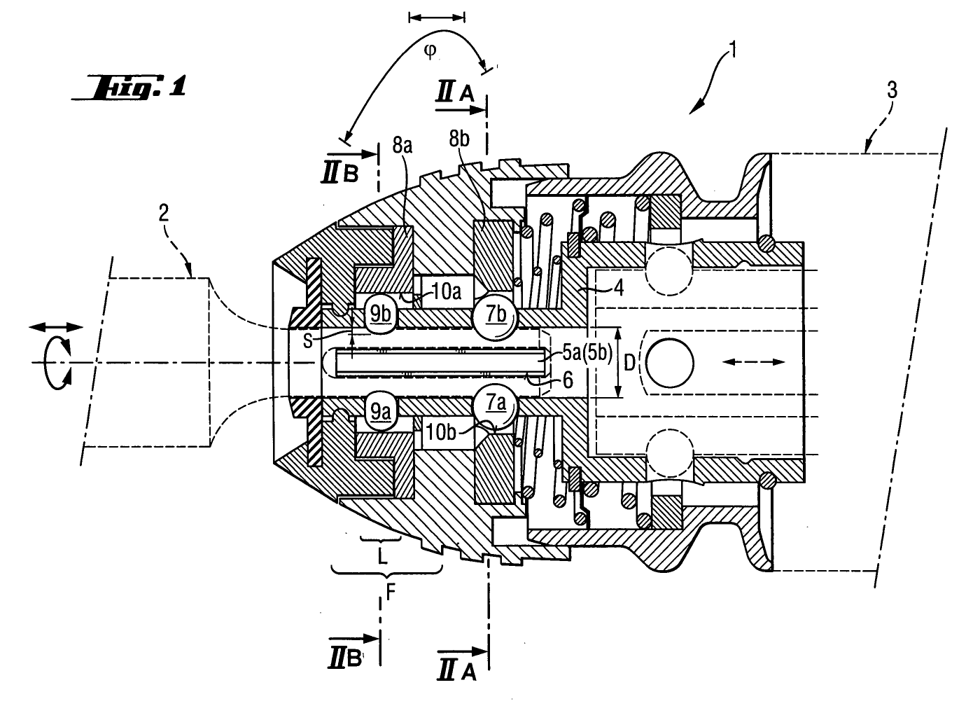

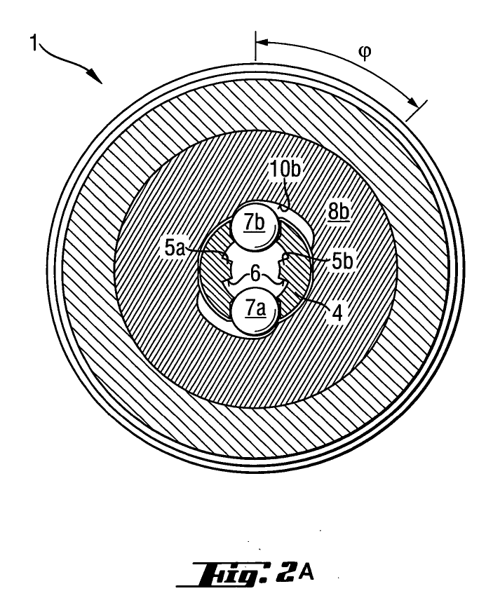

A chuck 1 according to the present invention for receiving a rotary-percussion working tool 2 driven by a power tool 3, which is shown in FIGS. 1, 2a, and 2b, includes two, located directly opposite each other, strip-shaped rotation-transmitting webs 5a, 5b projecting radially inward from a hollow cylindrical receiving sleeve 4 having a guide diameter D, and two, radially displaceable locking members 7a, 7b that are formed as balls. The rotation-transmitting webs 5a, 5b have respective radially extending contact surfaces 6. In the receiving sleeve 4, in the working tool-side region F of the guide diameter D, there are provided, between the two rotation-transmitting webs 5a, 5b, two guide members 9a, 9b which are displaceable radially inwardly with a rotatable, externally operated, first clamping sleeve 8a. The guide members 9a, 9b are formed as segments of hollow cylinders the axial guide length of which amounts to a half of the guide diameter D of the receiving sleeve 4. In the first clamping sleeve 8a, there is provided a first slide guide 10a along which the radially displaceable guide members 9a, 9b formlockingly slide upon rotation of the first slide guide 10a by an angle φ. With the rotational angle φ of the first clamping sleeve 8a of 45°, the guide members 9a, 9b are displaced radially inward in the guide diameter D. As a result, the guide members 9a, 9b are displaced in a rotational position suitable for a rotary boring (shown in FIG. 2b), spanning a clearance S (FIG. 1). In another, not shown rotational position of the first clamping sleeve 8a, which is suitable for a percussion boring, the guide members 9a, 9b are located radially outwardly of the guide diameter D by 0.2 mm. The two locking members 7a, 7b are radially displaced by a rotatable second clamping sleeve 8b having a second slide guide 10b formed therein along which the locking members 7a, 7b slide upon rotation of the second clamping sleeve 8b by the angle φ. Thus, in addition to a front guide set that consists of two guide members 9a, 9b, there is provided a rear power tool-side guide set formed of the two locking members 7a, 7b which also act as guide members.

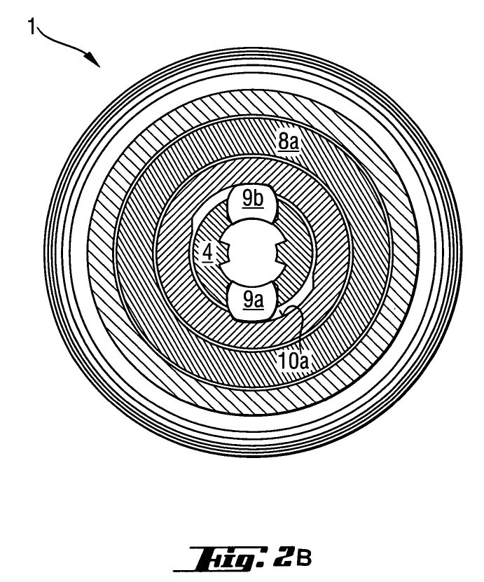

In FIG. 3, which shows a cross-sectional view similar to that of FIG. 2b of another embodiment of the chuck 1, there are provided, in the receiving sleeve 4, three, symmetrically arranged and tangentially displaceable, locking or guide members 91, 9b, 9c. The guide members 9a, 9b, 9c are formed as balls which are radially displaceable by a first clamping sleeve 8a having a first slide guide 10a and rotatable by an angle of 110°.

Though the present invention was shown and described with reference to the preferred embodiments, such are merely illustrative of the present invention and are not to be construed as a limitation thereof and various modifications of the present invention will be apparent to those skilled in the art. It is, therefore, not intended that the present invention be limited to the disclosed embodiments or details thereof, and the present invention includes all variations and/or alternative embodiment within the spirit and scope of the present invention as defined by the appended claims.

What is claimed is:

1. A chuck for receiving a working tool driven by a power tool, the chuck comprising a hollow cylindrical sleeve (4) for receiving the working tool (2) and having a guide diameter (D); strip-shaped rotation-transmitting webs (5a, 5b) projecting radially inward from the receiving sleeve (4) and having contact surfaces (6); at least one radially displaceable locking member (7a); at least two guide members (9a, 9b) provided in a working tool-side guide region (F) of the guide diameter (D) and spaced from the rotation-transmitting webs (5a, 5b); and a manually rotatable clamping sleeve (8a) for displacing the guide members (9a, 9b) radially inwardly.

2. A chuck according to claim 1, wherein the guide members (9a, 9b) are arranged between the rotation-transmitting webs (5a, 5b) and are tangentially displaceable therebetween.

3. A chuck according to claim 1, wherein an axial guide length (L) of the guide members (9a, 9b) amounts to between half and total of the guide diameter (D).

4. A chuck according to claim 1, wherein the clamping sleeve (8a) provides for a maximal rotational angle (φ) of 120°.

5. A chuck according to claim 1, wherein the guide members (9a, 9b) are located radially outwardly of the guide diameter (D) by at least 0.1 mm in a rotational position of the clamping sleeve (8a).

6. A chuck according to claim 1, wherein the clamping sleeve (8a) has at least one slide guide (10a) formed therein along which the radially displaceable guide members (9a, 9b) slide upon rotation of the clamping sleeve (8a) by an angle φ.

7. A chuck according to claim 1, wherein in addition to the at least two guide members (9a, 9b) which form a front guide set, there are provided at least two further guide members (7a, 7b) one of which is formed by the at least one locking member (7a) and which form a rear guide set arranged in a power tool-side guide region spaced from the working tool side region; and a further rotatable clamping sleeve (8b) for radially displacing the further guide members (7a, 7b).

8. A chuck according to claim 1, wherein the at least two guide members (9a, 9b) are formed as segments of hollow cylinders.

9. A chuck according to claim 1, wherein there are provided three guide members (9a, 9b, 9c) circumferentially symmetrically spaced from each other.

10. A chuck according to claim 7, wherein both further guide members (7a, 7b) are locking members.
